(19) United States
(12) Patent Application Publication
(10) Pub. No.: US 2003/0160087 A1
(43) Pub. Date: Aug. 28, 2003

(54) Method of soldering metallic components by means of a tube-shaped connection piece and cryogenic devices made by said method

(75) Inventors: Engelbert Blabsreiter, Rosenheim (DE); Walter Huber, Oberhaching (DE); Ludwig Joas, Flintsbach (DE)

Correspondence Address: CROWELL & MORING LLP, INTELLECTUAL PROPERTY GROUP, P.O. BOX 14300, WASHINGTON, DC, 20044-4300, US

(73) Assignee: Astrium GmbH

(21) Appl. No.: 10/370,627

(22) Filed: Feb. 24, 2003

(30) Foreign Application Priority Data
Feb. 22, 2002 (DE) 102 07 607.3

(51) Int. Cl. B23K 31/00

(52) U.S. Cl. 228/180.21

(57) ABSTRACT

A method is provided for soldering at least two metallic components, one end of each of the metallic components being soldered with the aid of a tube-shaped connection piece. Furthermore, a use of such a soldering process is provided for soldering a wire to a metallic contact, specifically for a use in the case of cryogenic devices.

### BACKGROUND AND SUMMARY OF THE INVENTION

This application claims the priority of German Patent Application No. 102 07 607.3 filed Feb. 22, 2002, the disclosure of which is expressly incorporated by reference herein.

The present invention relates to the problem connected with soldering metallic components. Normally, the metallic components are covered by means of a solder during the soldering and are directly soldered to one another. However, this type of connection may present problems in certain applications and loads, for example, when metallic components are to be connected which, in the operating condition, are subjected to very different temperatures. In such a case, the use of at least one metallic component with a low thermal conductivity is required.

This prerequisite is met by thin wires, for example, made of stainless steel, but a connection of such a thin wire with other metallic components, such as plugs, by means of the above-mentioned method is problematic because of the free-cutting effect from the softer solder occurring during tensile stress. Similar problems may also occur in other applications of solder connections in the case of which tensile stresses have to be compensated or in the case of which, for example, a soldering of the metallic components cannot easily be implemented.

It is therefore an object of the present invention to provide a possibility which ensures a reliable soldering of metallic components and a higher stability of the soldered connection with respect to tensile stress.

This object is achieved according to certain preferred embodiments of the invention by providing a method of soldering at least two metallic components, comprising introducing a first end respectively of the metallic components into a tube-shaped connection piece which, at least in a partial area of its surface, has a coating of a solder and whose inner contour corresponds largely to an outer contour of at least one of the first ends of the metallic components, and soldering the first ends of the metallic components to the tube-shaped connection piece.

This object is also achieved according to certain preferred embodiments of the invention by using said method for soldering a wire to a metallic component.

A method of soldering at least two metallic components is described. This method is characterized by the following steps:

(i) Introduction of a first end respectively of the metallic components into a tube-shaped connection piece which, at least in a partial area of its surface, has a coating by means of a solder and whose inner contour corresponds largely to the outer contour of at least one of the first ends of the metallic components; and

(ii) Soldering the first ends of the metallic components to the tube-shaped connection piece.

The tube-shaped connection piece may have either a partial or complete surface coating of a soldering material, such as tin, or the small tube may even completely consist of a soldering material, for example, of a precious metal, particularly of silver or gold, or of a precious metal alloy. Depending on the field of application of the soldered connection, other conventional soldering materials are also conceivable. Thus, according to the method, not only a soldering-together of two metallic components takes place with one another but a soldering of each of the metallic components takes place with the tube-shaped connection piece which encloses them at one end and which represents the main connection between the metallic components. As a result, as a secondary effect, a soldering-together of the metallic components with one another can additionally take place.

Instead of obtaining a more punctiform soldered connection, as according to the state of the art, the possibility is now provided of creating a more extensive soldered connection which is easier to implement and ensures a better absorption of tensile forces in the event of tensile loads, particularly because of the surrounding arrangement of the connection piece.

The inner contour of the tube-shaped connection piece is adapted to the outer contour of at least one of the first ends, so that, after the introduction of the ends into the tube-shaped connection piece, the inner contour of the tube-shaped connection piece ideally rests approximately on the outer contour of at least one of the ends, or at least only a short distance exists between the inner contour of the tube-shaped connection piece and the outer contour of at least one of the first ends.

In order to achieve a better soldering of the first ends to the tube-shaped connection, the first ends may be coated with a solder before the introduction of the first ends into the tube-shaped connection piece.

It may also be provided that, before the soldering-together, the first ends are already fixed in their soldering position relative to one another so that, during the soldering, no mutual shifting or sliding-apart of the first ends can now take place. For this purpose, before the introduction of the first ends into the tube-shaped connection piece, the first ends can be mechanically connected with one another, for example, by a form-locking connection of the first ends or by additional fastening devices or clamping devices, such as a clamp, a shrinkable sleeve, a bonding agent, or the like. The first ends are then introduced into a first end opening of the tube-shaped connection piece, and the tube-shaped connection piece is slid on the metallic components away from the first ends of the metallic components until both first ends of the metallic components emerge from a second end opening of the tube-shaped connection piece.

As described above, the present invention can particularly advantageously be used for the soldering-together of a wire and a metallic contact. Particularly, when wires are soldered, a secure and durable soldered connection is important, specifically when the wire is exposed to tensile stress, for example, by thermal length changes because of different operating temperatures on both sides of the soldered connection. The method according to the invention can particularly be used for the soldering of a wire of a diameter of less than or equal to 0.5 mm; specifically, for soldering a wire of a diameter of less than or equal to 0.1 mm to a metallic contact. The method can be used, for example, when wires of a lower thermal conductivity, thus, for example, steel wires, have to be soldered to a metallic contact, specifically, when thin steel wires are involved.

In particular, the method can be used for soldering a wire which is a component of a cryogenic device. Another object of the present invention is a cryogenic device having at least one soldered connection which was established by means of an above-described method. Such a cryogenic device, which may be implemented, for example, in the fields of cryophysics, aerospace engineering, medical technology or similar fields, has at least one component which clearly has a lower temperature than other components of the device. Examples are devices which use liquid gases at a low temperature as operating or cooling mediums. The field of application of the soldered connection may in this case cover temperatures of below 100 K of the colder components, possibly even temperatures below 50 K. Specifically here, the stability of the above-mentioned soldered connections is particularly important, specifically for soldering metallic conductors of a low thermal conductivity.

A special embodiment will be explained in detail in the following by means of FIGS. 1 to 6.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic representation of a soldered connection according to the invention between a thin wire and a plug contact;

FIG. 2(a) is a schematic lateral view representation of a tube-shaped connection piece used in making the connection of FIG. 1;

FIG. 2(b) is a schematic top view of the tube-shaped connection piece of FIG. 2(a);

FIGS. 3(a) and 3(b) are cross-sections of two alternative embodiments of the connection piece according to FIG. 2;

FIG. 4 is a schematic representation of the fixing and soldering of the wire and the plug contact to form the connection of FIGS. 1-3;

FIG. 5 is an enlarged cutout and a cross-sectional representation of a soldered connection with a connection piece according to FIG. 3(a); and

FIG. 6 is an enlarged cutout and a cross-sectional representation of a soldered connection with a connection piece according to FIG. 3(b).

### DETAILED DESCRIPTION OF THE DRAWINGS

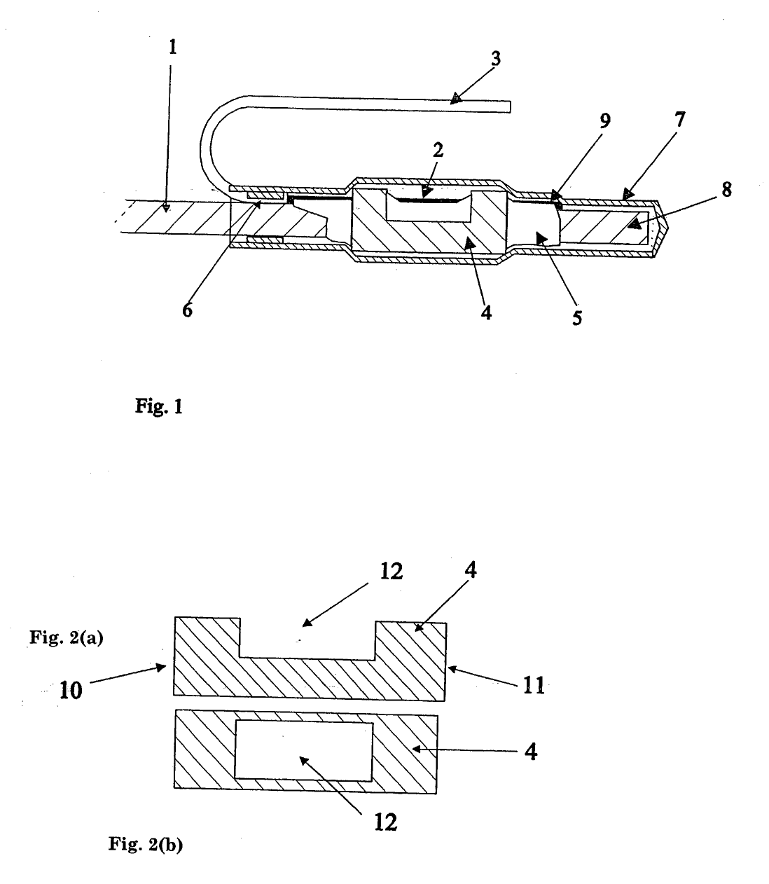

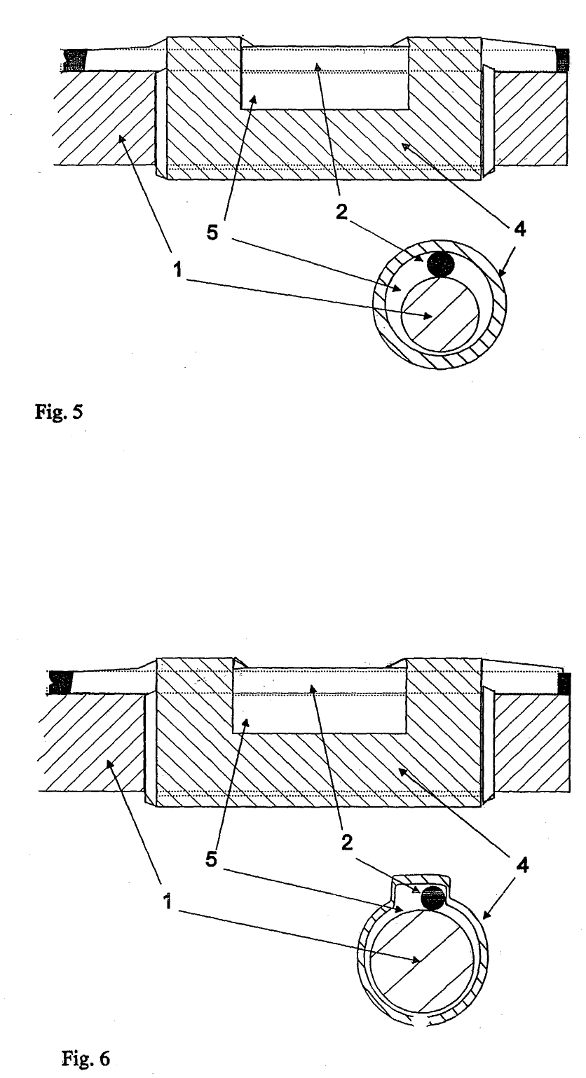

FIG. 1 illustrates a soldered connection established according to the invention between a thin wire 2, for example, made of stainless steel and having a diameter of less than or equal to 0.1 mm which therefore has a low thermal conductivity, and a plug contact in the form of a plug pin 1. The plug pin 1 and the wire 2 therefore form two metallic components to be soldered. In a partial area which is not to be soldered, the wire 2 may also be surrounded by an insulation 3. For a clearer representation of details, reference is made to FIGS. 4, 5 and 6. The plug pin 1 has a first end 8; the wire 2 has a first end 9. In principle, the outer contours of the wire 1 and of the plug contact 2 may be selected arbitrarily. For the purpose of simplicity, in the present example, the wire 2 as well as the plug pin 1, in their cross-section (see FIGS. 5 and 6), have a round outer contour.

The plug pin 1 and the wire 2 are soldered together by means of a tube-shaped connection piece 4 which was either coated by means of a solder or itself consists of a suitable soldering material. By means of the soldering, the molten and subsequently again solidified solder 5 forms a soldered connection between the plug pin 1, the wire 2 and the connection element 4. For fixing the plug pin 1 and the wire 2 before the soldering, the two components were connected with one another by means of a shrinkable sleeve 6 in a partial section adjoining the area of the soldered connection. For the electrical insulation of the soldered connection, the arrangement was surrounded by another shrinkable sleeve 7 after the soldering has taken place.

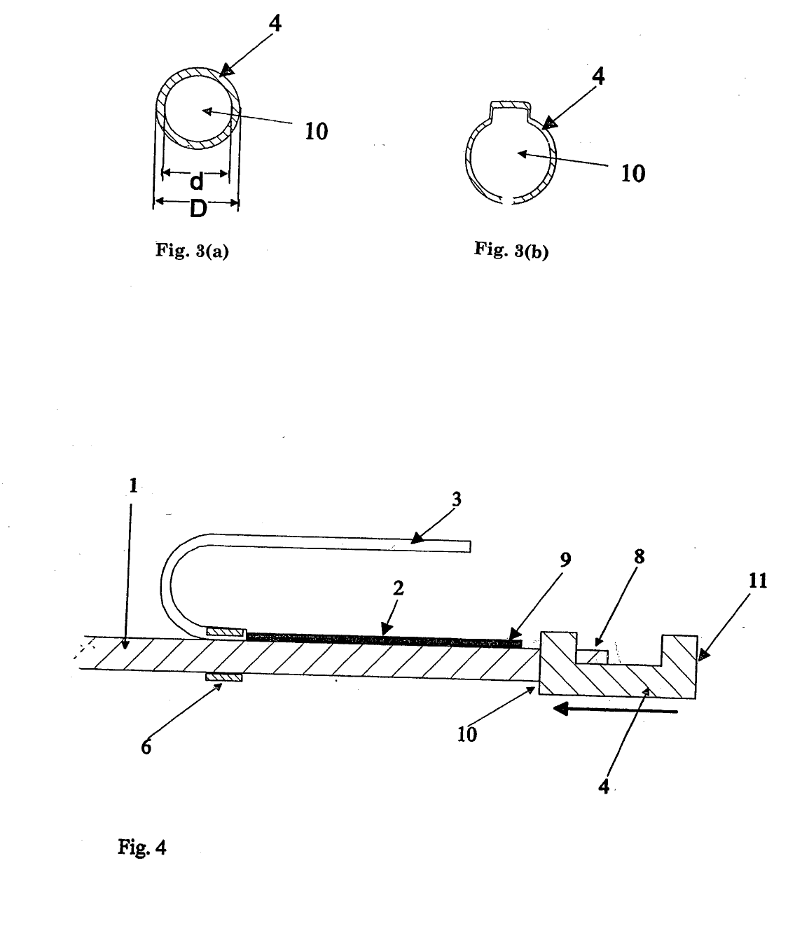

FIGS. 2(a) and 2(b) show a tube-shaped connection piece 4 which has a first end opening 10 and a second end opening 11, once as a lateral view (FIG. 2(a)) and once as a top view (FIG. 2(b)). The connection piece 4 either has a coating of a solder, such a tin, on its surface, or it consists itself of a soldering material, such as silver. The inner contour of the connection piece 4, particularly the inside diameter d of the end openings 10, 11 (see FIG. 3(a)) is selected such that it largely corresponds to the outer contour of at least the first end 8 of the plug contact 2, because, in the present embodiment, the latter has a diameter which is clearly larger than that of wire 1, and thus the outer contour of the entirety consisting of the plug contact 1 and the wire 2 is predominantly determined by the outer contour of the plug contact (see FIGS. 5 and 6). In the case of FIG. 3(a), the inner contour of the connection piece 4 is therefore selected to be as round as the outer contour of the plug contact 1; the inner diameter d of the connection piece 4 is selected to be so large that the entirety of the plug contact 1 and the wire 2 can be surrounded by the connection piece 4 (see FIG. 5). In the case of FIG. 3(b), the inner contour of the connection element 4 is adapted to the outer contour of the entirety consisting of the plug pin 1 and the wire 2 (see FIG. 5).

The connection piece 4 may be produced from a small tube (see FIG. 3(a)) or of a foil (see FIG. 3(b)). Either the connection element 4 may consist of a soldering material, such as silver, or a solder can be applied to the connection element 4, for example, by a galvanic pretinning. In the second case, the connection element 4 may consist of any suitable material which only has to offer the possibility of a galvanic tinning. One example of such a material would be nickel. If the connection element 4 is made of a foil, the foil can be bent by means of a bending device to the desired contour of the connection element 4. If the connection element 4 is produced from a small tube, the small tube can be shaped to the required inside diameter by cold drawing, can be cut to the desired length and subsequently can optionally be galvanically tinned.

In order to permit, before the soldering and optionally before a required coating of the connection element, a cleaning of the connection element 4 also on its inner contour and, in order to obtain, after the soldering, a control which is as extensive as possible by way of the quality of the soldered connection, the connection element 4 was provided with a window opening 12 which permits an easy access to the inner contour of the connection element 4 and, after a soldering, permits access to the soldering point for control purposes (see Figure 1).

In the area of the first ends 8, 9 of the wire 2 and of the plug contact 1 respectively, ideally before the soldering or still before the fixing of the plug contact 1 and the wire 2 by the shrinkable sleeve 6, a coating by means of a solder, such as tin, is applied. Ideally, the overall length of the thus coated areas of the two first ends 8, 9 corresponds at least to the overall length of the connection piece 4.

FIG. 4 is a schematic view of the soldering operation. The first ends 8, 9 of the plug contact 1 and of the wire 2 are mechanically fixed to one another; in the example according FIG. 4, by means of a shrinkable sleeve 6. Subsequently, the first ends 8, 9 are introduced into a first end opening 10 of the connection piece 4, and the connection piece is pushed in the direction of the arrow over the first ends 8, 9 onto the plug contact 1 and the wire 2 until both first ends 8, 9 of the plug contact 1 and of the wire 2 emerge from a second end opening 11 of the connection piece 4. Subsequently, the soldering of the plug contact 1 and of the wire 1 to the connection piece 4 takes place by heating the solder, whereby finally a soldered connection is established between the wire 2 and the plug contact 1 by way of the connection piece 4, and for a feature loading of the soldered connection in the later operation, a mechanical securing of the soldered connection is ensured by the connection piece 4.

In preferred embodiments utilizing a round cross section wire 2 and/or round contact 1, the diameter of the contact 1 is at least twice, and preferably more than 5 times the diameter of the wire 2.

The soldered connection according to the invention can be used particularly for applications, in which components exist which have a clearly different operating temperature, as particularly in cryogenic devices. One example, are applications in aerospace engineering, in which, for example, cryogenic satellite payloads or containers for cryogenic fuels form a component of a spacecraft. The described soldered connection can, however, also be used in other cryogenic devices.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. Method of soldering at least two metallic components, comprising:
introducting a first end respectively of the metallic components into a tube-shaped connection piece which, at least in a partial area of its surface, has a coating of a solder and whose inner contour corresponds largely to an outer contour of at least one of the first ends of the metallic components, and
soldering the first ends of the metallic components to the tube-shaped connection piece.

2. Method according to claim 1, comprising coating the first ends with a solder before the introduction of the first ends into the tube-shaped connection piece.

3. Method according to claim 1, comprising mechanically connecting the first ends with one another before the introduction of the first ends into the tube-shaped connection piece, the first ends being introduced into a first end opening of the tube-shaped connection piece, and the tube-shaped connection piece being pushed onto the metallic component away from the first ends of the metallic components until the two first ends of the metallic components emerge from a second end opening of the tube-shaped connection piece.

4. Method according to claim 2, comprising mechanically connecting the first ends with one another before the introduction of the first ends into the tube-shaped connection piece, the first ends being introduced into a first end opening of the tube-shaped connection piece, and the tube-shaped connection piece being pushed onto the metallic component away from the first ends of the metallic components until the two first ends of the metallic components emerge from a second end opening of the tube-shaped connection piece.

5. Use of a method according to claim 1, for soldering a wire to a metallic contact.

6. Use of a method according to claim 2, for soldering a wire to a metallic contact.

7. Use of a method according to claim 3, for soldering a wire to a metallic contact.

8. Use according to claim 5, for soldering a wire of a diameter of less than or equal to 0.5 mm to a metallic contact.

9. Use according to claim 6, for soldering a wire of a diameter of less than or equal to 0.5 mm to a metallic contact.

10. Use according to claim 7, for soldering a wire of a diameter of less than or equal to 0.5 mm to a metallic contact.

11. Use according to claim 8, for soldering a wire of a diameter of less than or equal to 0.1 mm to a metallic contact.

12. Use according to claim 9, for soldering a wire of a diameter of less than or equal to 0.1 mm to a metallic contact.

13. Use according to claim 10, for soldering a wire of a diameter of less than or equal to 0.1 mm to a metallic contact.

14. Use according to claim 5, for soldering a steel wire to a metallic contact.

15. Use according to claim 6, for soldering a steel wire to a metallic contact.

16. Use according to claim 7, for soldering a steel wire to a metallic contact.

17. Use according to claim 1 for soldering a wire as a component of a cryogenic device.

18. Cryogenic device having a soldered connection produced according to a process of claim 1.

19. A soldered connection for a cryogenic device, comprising:
a wire having a small cross-section;
a contact piece having a larger cross-section than the wire;
a tube-shaped connection piece surrounding a section of said wire and contact piece which are contacting one another, and
solder on an inside surface of the connection piece connected with said wire, said contact piece and said connection piece.

20. A soldered connection according to claim 19, wherein said contact piece has a cross-section which is at least twice as large as the cross-section of the contact piece.

21. A soldered connection according to claim 20, wherein the contact piece cross-section is at least four times as large at the wire cross-section.

22. A soldered connection according to claim 20, wherein said wire is a cylindrical steel wire having a diameter no greater than 0.1 mm.

23. A soldered connection according to claim 20, wherein said connection piece has a tubular shaped thru opening for the wire and connection piece and a laterally open window intermediate ends of the connection piece.
